(19) United States
(12) Patent Application Publication
(10) Pub. No.: US 2008/0025013 A1
(43) Pub. Date: Jan. 31, 2008

(54) LED-POWERED DENTAL OPERATORY LIGHT

(75) Inventors: H. Thomas Lockamy, Charlotte, NC (US); Austin Everett Unsworth, Fort Mills, SC (US)

Correspondence Address: TRASK BRITT, P.O. BOX 2550, SALT LAKE CITY, UT, 84110, US

(73) Assignee: PELTON & CRANE, Charlotte, NC (US)

(21) Appl. No.: 11/867,876

(22) Filed: Oct. 5, 2007

Related U.S. Application Data
(63) Continuation-in-part of application No. 11/120,170, filed on May 2, 2005.

(51) Int. Cl. F21V 7/00

(52) U.S. Cl. 362/33

(57) ABSTRACT

A lamp assembly adapted to cast shadow-free illumination over an area. Typically, a lamp assembly includes a plurality of light modules that are disposed in a spaced apart relationship over an area. The lamp assembly can be arranged to focus light from the lamp to a central area of illumination of high intensity, with significantly reduced intensity illumination outside the central area.

### RELATED U.S. APPLICATION DATA

This application is a continuation-in-part of application Ser. No. 11/120,170, filed May 2, 2005, published as Pub. No. U.S. 2006/0245173 A1 on Nov. 2, 2006. The disclosure of the previously referenced U.S. patent application is hereby incorporated herein by reference in its entirety.

### FIELD OF THE INVENTION

This invention relates to apparatus that produce visible light. It is particularly directed to an electrically powered light source including a light emitting diode (LED), which is adapted for use in a dental operatory.

### BACKGROUND OF THE INVENTION

It has been known for an extended period of time that electricity may be harnessed to create visible light. Incandescent light emitting elements powered by electricity have been used for substantially the same period of time. However, such incandescent lights suffer from an inefficient conversion of electricity to visible light. The inefficient conversion process causes production of a considerable amount of heat, and emission of a significant amount of radiation in, or near, the infrared spectrum. Such infrared emission inherently casts a heat load onto a target along with an illuminating beam. The heat generated by incandescent lighting may sometimes place an undesirable burden on environmental control systems, such as cooling systems used in dwellings. Both the inefficient conversion process, and removing the undesired heat load from the area near the light, lead to a correspondingly larger than necessary electric utility bill. Furthermore, in use on an operatory to illuminate an operating site on a patient, the infrared emissions may undesirably dry illuminated tissue, or may produce a feeling of discomfort in the patient.

Alternative light emitting elements include fluorescent light bulbs. Such fluorescent bulbs advantageously produce a reduced heat load compared to incandescent bulbs. However, fluorescent bulbs tend to be bulky, and generally produce light of a less desirable color and intensity for many applications. Furthermore, certain electrical components required in the electric circuit powering the fluorescent bulbs, such as the ballast, tend to produce an undesirable amount of noise. In use in an operatory, it is generally desired to reduce the bulk of a lamp fixture, to reduce its intrusion into the operating arena, and to facilitate ease of manipulation of the lamp fixture.

It would be an improvement to provide a more energy-efficient lamp fixture capable of producing a reduced heat load, and casting substantially shadow-free illumination having a desirable color and intensity.

### SUMMARY OF THE INVENTION

The present invention provides an LED-powered light source particularly adapted for use in a dental operatory. However, the light source of the invention is not limited in application to dental operatories. It finds exemplary use in other medical operatories, or in industry or craft applications that benefit from employment of a light source capable of casting substantially shadow-free illumination over an area, or of a visible light source having a reduced power consumption and/or heat output.

The light source structures of this invention may ordinarily be embodied as a lamp assembly. Such assemblies typically include a housing adapted to support one or more bulbs, modules, or comparable light-emitting components. The housing will often include various mechanical and/or electronic control components. In any case, light is typically directed or reflected from the housing through an opening or lens. The portion of the lamp closest to the illumination target in use is conventionally referred to as the “front” of the lamp. Light is thus regarded as emanating from the front of the lamp.

The instant invention may be embodied to provide one or more of a variety of improvements over conventional illuminating lamp structures having incandescent light sources. A lamp structured according to one embodiment of the instant invention can be fashioned to provide illumination within a band selected from within a wide range of color temperatures. Certain such lamps may be further structured and arranged to permit selected varying of the color temperature of the emitted light. In a particular embodiment, a dental operatory lamp used to illuminate an operating area comprises: a housing having a front directed toward the operating area and a rear away from the operating area; a reflector module located at the rear of the housing; a plurality of light emitting diodes (LEDs) on the reflector module; an electrical power supply for supplying electrical power to the LEDs for illuminating the LEDs, with the power supply being selectively operable to provide an intensity adjustment for the LEDs. A lamp of this invention may be configured to permit a virtually infinite intensity adjustment of its output light (e.g. 0 to 2500 FC or more).

Certain embodiments of the invention provide illumination of a target area without producing any significant amount of stray light. A dental patient's eyes can thus be spared the irritation normally associated with the stray light from an illuminating device of sufficient intensity to illuminate fully the patient's mouth in the target region of a lamp.

For most applications, the illuminated target region is considered to have an approximately flat footprint and a depth normal that footprint. That is, the illuminated region is generally structured to encompass a volume disposed proximate the footprint effective to illuminate 3-dimensional structure, such as a dental patient's oral cavity (a “target”). For purpose of this disclosure, the illuminated region (within which a “target” is located) may be viewed as a volume defined by a “footprint” (e.g., the illuminated area of a table top or wall) and the illuminated space directly adjacent the footprint. The lamp that is casting the illumination can, for convenience, be imagined to be aimed at a vertical surface, such as a wall. However, such reference is for convenience of description only, and the lamp may be aimed or otherwise oriented in space as desired, with corresponding changes made to the shape or orientation of the illuminated footprint. A footprint might encompass any shape, including rectangular, oval, circular, or irregular.

The preferred light sources (one or more high-powered LEDs emitting radiation having one or more wavelengths in a visible spectrum) inherently possess a long life, which reduces maintenance requirements in a lamp. The spectrum of emitted light from a lamp can be fixed in a range to reduce emitted UV wavelengths, thereby affording improved working time for a clinician to work with UV-cured adhesives or composites. The emitted light from certain desirable LED sources inherently has a reduced component of waves near the infrared spectrum, thereby resulting in greatly reduced heat output from the front of the lamp. The reduced heat output enhances a dental patient's comfort while that patient is in the illuminated target area of a lamp, and reduces tissue drying (e.g. in a medical operatory).

LED light sources may be selected for their emitted spectrum, and mixed in combination within a lamp to produce a desired lamp output intensity and/or color. Different color LEDs may be disposed at selected locations in a lamp to form, in combination, a lamp output having a certain color. The intensity of the lamp's output can, in some cases, be controlled by use of a microprocessor. Of course, a variable number of LED-powered visible light sources may simply be turned on at one time alternatively to control a lamp's output intensity and/or color.

A further advantage provided by certain desirable LED light sources is their reduced power requirement. A lamp including one or more LED-powered light source draws a reduced amount of electricity to generate a similar amount of light output compared to an incandescent lamp of similar intensity. Because the conversion of electric power to visible light is efficient in an LED light source, the heat generated in that process is reduced compared to incandescent light sources. Therefore, a lamp constructed according to the invention produces a reduced heat load on the environment in which that lamp is placed. A correspondingly reduced strain is thereby placed on environmental control facilities, such as a local air conditioning system. The reduced electricity consumption of the LED-powered lamp results in a direct reduction in a user's electricity cost. Current estimates are that an LED powered lamp will replace a comparable-intensity incandescent lamp at an approximately 60% reduction in power consumption.

A lamp constructed according to the instant invention typically incorporates a combination of one or more high powered LEDs that form one or more light emitting source. Desirably, at least for dental applications, the emitted light produces an elliptical-shaped, shadow-reduced, light pattern of variable intensity and color temperature. When a plurality of light sources is provided, it is generally preferred to arrange their respective outputs to produce an overlapping feathered-edge pattern. This expedient offers several benefits, particularly the reduced likelihood of eye fatigue of a clinician or other user.

The improved LED-powered lamps may be manufactured to permit making adjustments in a focus length between a lamp and a target area. Adjustments may be provided also to control the shape of the illuminated pattern at different focus distances. Other ease-of-use features desirably are included, such as forming the lamp to facilitate maintenance. One such feature is providing a lamp with a hinged portion of the housing or back (or Lens area), to permit ready access to replace or maintain the light source(s).

In another embodiment, a dental operatory lamp used to illuminate an operating area comprises: a housing having a front directed toward the operating area and a rear away from the operating area; at least one reflector module at the rear of the housing comprising a plurality of tubes, wherein the tubes are positioned with their longitudinal axes aligned toward predetermined points within the operating area for directing the light from the LEDs toward the front of the lamp in a pattern that focuses light from the lamp to a central area of illumination of high intensity, with significantly reduced intensity illumination outside the central area; and a plurality of LEDs. one of the LEDs being positioned in each of the tubes, and a portion of the respective tube projecting forward of the LED toward the front of the lamp to direct the light emitted from the LED toward the operating area.

Preferred dental lamps constructed according to the invention are shaped and dimensioned to permit an operator and an assistant to move in close to a patient's oral cavity without obstructing the operating area with shadows. It is further desirable that the lamp be structured and arranged to occupy a nonintrusive volume. Such lamps may provide a narrow vertical shape at the lamp body, and orient or focus the LED light source's output onto an illuminated area having a reduced vertical size. In some instances, a lamp focus may be adjusted to produce either an increased or decreased horizontal size, compared to the corresponding size of the lamp.

It is within contemplation that a variety of LED light sources, each source providing one or more color, wavelength spectrum, or intensity, may be combined in a lamp. In certain currently preferred embodiments adapted for dental use, a plurality of individual reflector modules, each containing an LED light source, are mounted on a lamp structure to shape and direct the emitted light toward a target. The reflector modules can be pitched or tilted to focus their emitted light toward a desired target. For example, in one currently preferred embodiment, a plurality of LED-powered reflector modules are arranged in an arcuate array and oriented to aim their individual light beams to provide shadow-free impingement on a region with a footprint having a reduced area compared to the area of the front of the lamp.

In one embodiment, a dental operatory lamp used to illuminate an operating area comprises: a housing having a front directed toward the operating area and a rear away from the operating area; a reflector module located at the rear of the housing; a plurality of light emitting diodes (LEDs) on the reflector module; and a curved or faceted interior reflective surface of the lamp housing and wherein the LEDs are directed toward the curved or faceted interior reflective surface for directing the light from the LEDs toward the front of the lamp in a pattern that focuses light from the lamp to a central area of illumination of high intensity, with significantly reduced intensity illumination outside the central area. In one particular lamp construction, light output from one or more LED source(s) is directed rearward for reflection from a curved or faceted interior surface of lamp structure to focus on a target area at a distance from a front portion of the lamp. A lamp structured for use in the dental environment might produce an illuminated target area of about 3 inches high by about 8 inches wide at a distance of about 18 to 36 inches from the lamp front. The LED source itself can sometimes function as a self-contained reflector module. Another alternative construction disposes a plurality of LED light sources in an arcuate, or other-shaped, distribution to focus emitted visible light forward toward a target area located at a distance from the front of the lamp. In the latter construction, lamp structure holding the LED light sources can sometimes also operate as a reflector surface to direct certain emitted light in a forward direction.

In certain embodiments of the invention, the light output of a plurality of LED light sources, arranged in individual reflector modules and focused toward a target, can be transmitted through a refractor lens positioned at a front of a lamp and operable to create a light pattern and color temperature on the target. Operable lenses may provide converging and/or mixing of the output from the individual light sources. Certain operable such refractor lenses are multifaceted. Functional lenses may range from simple translucent coverings having no significant effect on transmitted light, to complexly arranged members operable significantly to effect a propagation direction. or physical quality, of transmitted light. In some instances, a plurality of individual lenses may be concatenated to form a single lamp lens. Lenses may be clear, or may modify a color in the transmitted light.

Embodiments of a lamp manufactured according to principles of the instant invention need not include a front lens. However, in use in an environment such as a dental operatory, it is preferred to provide a front lens as a protective cover to block migration of dust and contaminated aerosols into the lamp interior. A front surface of such a lens may be structured to provide an easily cleanable surface, whereby to maintain sterility of the operatory area. Whether or not a focusing lens is provided, a shield made from Lexan®, or other similar material, desirably is provided to completely encase the front of a dental lamp to resist contamination of, and to facilitate cleaning of, the lamp. Furthermore, it sometimes is desirable to provide a scratch-resistant ceramic frit.

In one currently preferred embodiment of the invention, a lamp is formed to replace a commercially available dental operatory lamp. The improved lamp provides equal or higher light output to, and retains the basic light pattern of, the commercially available lamp. Therefore, a user may not notice a substantial change in performance when changing to the improved lamp. In fact, the improved lamp can provide one or more features to even enhance that user's experience. Desirably, the improved dental lamp is free from stray light, and has a temperature of the projected light that is variably adjustable in color from, e.g., about 3600K or less, to, e.g., about 4200K, and in some instances up to about 5000K or more. Lamps having a fixed color output are also within contemplation.

LED-powered dental lamps desirably are variably adjustable in intensity, ranging from 0 to over 2,500 foot-candles. An exemplary range may be from about 1500 foot candles, to about 2000 foot-candles, and more advantageously up to about 2500 foot-candles, or more. at a distance of about 27 inches from. the lamp.

The low heat output of the improved lamp enhances comfort of the patient and clinician—both by projecting a lower heat load onto a patient, and by providing a cooler lamp housing. It is currently preferred to use high-intensity LED sources, although low-intensity sources are also workable. Typical LED sources used in the invention are efficient at producing primarily visible light output and low heat at low applied voltages. In use, the improved lamp typically provides a cool front portion and a warm rear portion. The lamp's housing generally is constructed to convey any heat produced by the LED source(s) to the room by convection and radiation. An exemplary lamp housing typically includes a metal, or other heat-conducting material, arranged at a rear portion of the lamp to dissipate such heat output away from the lamp and patient.

In yet another embodiment, a dental operatory lamp used to illuminate an operating area comprises: a housing having a front directed toward the operating area and a rear facing away from the operating area; a plurality of light emitting diodes (LEDs), each LED being positioned in a respective stray light tube; and an adapter configured for receiving at least one non-light emitting diode (non-LED) light source within the housing.

### BRIEF DESCRIPTION OF THE SEVERAL VIEWS OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIG. 1 is a side view representation of a dental operatory lamp constructed according to principles of the invention;

FIG. 2 illustrates a component arrangement and a corresponding light output for a module;

FIG 3 is a cross-section taken along an axis of a light module constructed according to principles of the invention;

FIG. 4 illustrates a representative illumination pattern for the dental operatory lamp according to one embodiment of the invention;

FIG. 5 is a cross-section of a light module having a reflective interior reflective surface according to a particular embodiment of the invention;

FIG. 6 is an end view of a first collimating lens used in certain embodiments of the invention;

FIG. 7 is a cross-section taken through section 5-5 in FIG. 6 and looking in the direction of the arrows; and

FIG. 8 is a cross section, similar to FIG. 7, taken through a second, alternative, collimating lens.

### DETAILED DESCRIPTION OF THE INVENTION

Although the foregoing description contains many specifics, these should not be construed as limiting the scope of the present invention, but merely as providing illustrations of some representative embodiments. Similarly, other embodiments of the invention may be devised that do not depart from the spirit or scope of the present invention. Features from different embodiments may be employed in combination.

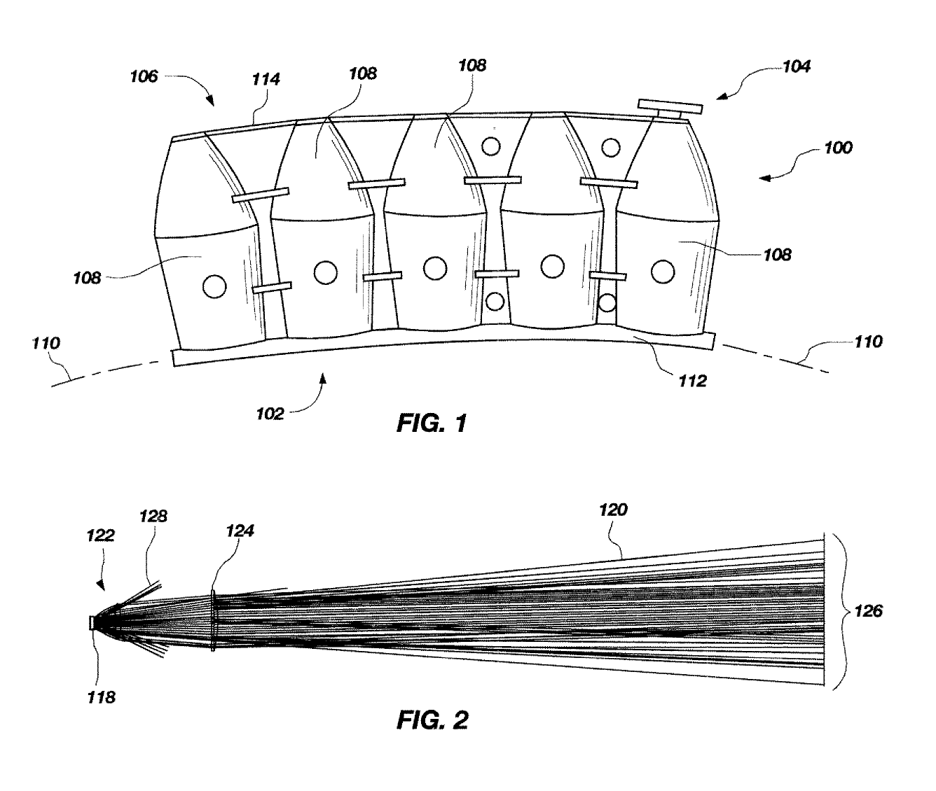

FIG. 1 illustrates a side view of a current embodiment of the invention, generally indicated at 100, of a light source structure constructed according to principles of the invention. Light source structure 100 may generally be characterized as a lamp. Lamp 100 is powered by electricity, and functions to provide illumination to a work area disposed a distance from the lamp front, generally indicated at 102. Desirably, the work area illuminated by lamp 100 is shadow-free, and appears relatively uniform in illumination color and intensity. For most applications, the illuminated target work area is considered to have an approximately flat footprint and a depth normal to that footprint. That is, the illuminated region is generally structured to encompass a volume disposed proximate the footprint.

Illustrated lamp 100 includes attachment structure, generally indicated at 104, operable to connect lamp 100 to suspension structure in the work area. Illustrated attach structure 104 is carried at a back 106 of lamp 104, although any convenient arrangement is operable. Typical suspension structure in a dental operatory permits a user to orient the lamp in space operably to aim the light output of lamp 100 at the desired target area. Certain embodiments of the invention provide a lamp having reduced weight and/or intrusive volume compared to commercially available lamps. Such reduced weight lamps permit a corresponding reduction in mass of the lamp suspension arrangement, thereby increasing ease of manipulation of the lamp to orient its output toward a target.

Lamp 100 includes a plurality of light modules 108 that may be disposed in an array and tilted along an arcuate path 110 to aim their collective light outputs to impinge on a desired target footprint. Illustrated light modules 108 are sometimes also called reflective modules. One representative row of modules 108 is visible in FIG. 1, although any number of such rows may be repeated in a columnar, staggered, or other arrangement in space to form a 3-dimensional lamp body providing the desired luminescent output.

One particular embodiment of the lamp assembly 100 includes 3 rows forming 5 columns of modules 108, for a total of 15 modules in the lamp. Such modules 108 are desirably spaced apart from each other and aimed in harmony to form illumination of a target region. It is currently preferred for an output of each module to be shaped to substantially illuminate the entire target footprint. Therefore, the target footprint can be fully illuminated by the sum of the outputs of modules 108. In such an arrangement, an object blocking light emitted by one, or even most, of the modules 108 still would not cast a shadow on the target footprint. A path along a column between rows may be a straight line, although such a path (not illustrated, but similar to path 110) can also be arcuate.

In use in an environment such as a dental operatory, a front shield 112 can be provided as a protective cover to block migration of dust and contaminated aerosols into the lamp interior. A front surface of such a shield 112 may be structured to provide an easily cleanable surface, whereby to maintain sterility of the operatory area. In certain embodiments, shield 112 may incorporate one or more lenses to focus, or otherwise modify, the light output of lamp 100. Whether or not a focusing lens is provided, a shield made from Lexan®, or other similar optically useful and formable material, can be provided to completely encase the front of a dental lamp to resist contamination of, and to facilitate cleaning of, the lamp. Illustrated shield 112 is injection molded, and includes focusing lenses for each of the modules 108 in a unitary part. Desirably, shield 112, or a portion of lamp housing 114, can be hinged, or otherwise openable by a user, to provide access to the interior of lamp 100 for maintenance or replacement of a light generating element.

With reference to FIG. 2, an LED 118 emits light indicated by a plurality of rays 120. An operable LED can include a 3 watt LED, such as that sold by Lumileds Lighting US, LLC under the Brand name Luxeon, part number LXHL-LW3C.

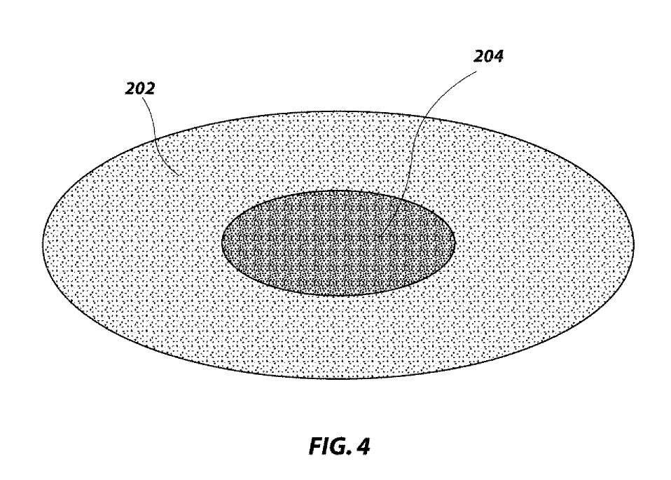

Typically, a reflective element, generally indicated at 122, is provided to direct the LED's light output toward a target. A focusing lens 122 may be included in an arrangement effective to collimate rays 120 and further direct them to an illuminated area indicated at 126. In certain embodiments of the invention, area 126 corresponds to the target footprint of the lamp 100. In such case, it is desired that the illumination emitted from each module 108 is substantially uniform over area 126. Certain rays 128 may be emitted in a direction other than desired for impingement on area 126. Such rays 128 are characterized as stray light. As indicated by the illustrated collection of rays 120, area 126 sometimes has a higher intensity of illumination at its center, and may fade to a decreased intensity near its perimeter, as discussed with reference to FIG. 4. In another embodiment, the LED 118, mirror 122, and all associated optics are arranged in harmony to produce a substantially uniform intensity over its illuminated footprint at a selected focal distance.

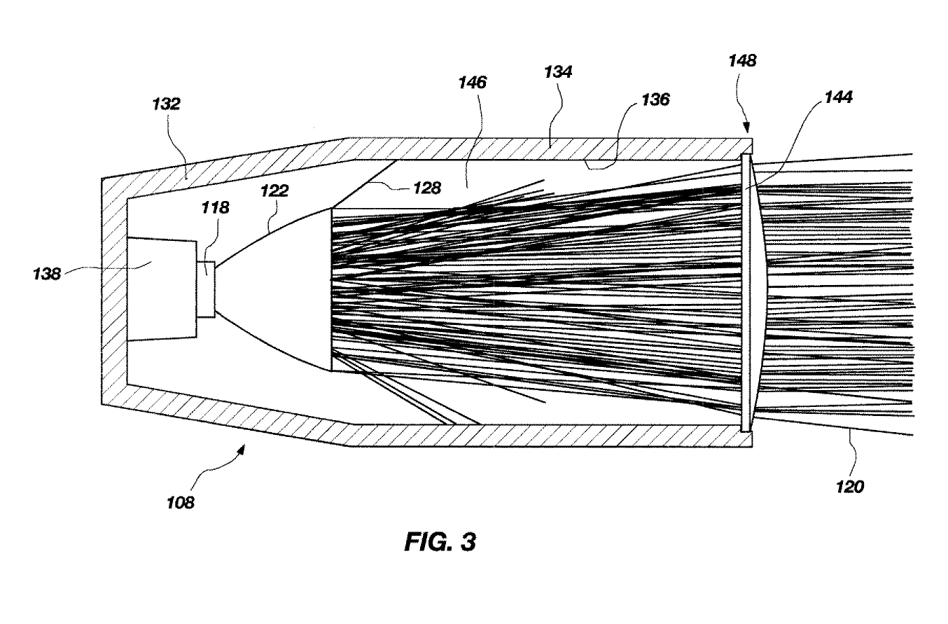

Another exemplary light module 108 is illustrated in FIG. 3. Housing 132 of illustrated module 108 includes a portion that forms a component stray light tube 134. An interior surface 136 of tube 134 may be reflective, but desirably is arranged to resist reflection of incident stray light rays 128 to reduce emission of such stray rays outside the target footprint. A preferred stray light tube 134 provides a black, or essentially light absorbing, surface 136 to resist reflection of stray light rays 128. It is within contemplation for a stray light tube 134 to be formed as a distinct component. However, including the stray light tube as a portion of the housing 132 reduces part count and cost, and simplifies assembly of a lamp 100.

LED 118 is typically mounted with respect to housing 132 by a conveniently structured foundation 138. Desirably, foundation 138 is structured to provide simple and rapid installation and removal of LED 118, and includes connection structure for the electricity supplied to the LED. It is further desirable for foundation 138 to be formed from a material capable of conducting heat. Advantageously, foundation 138 and housing 132 may be structured and arranged to dissipate any heat generated by LED 118 in a direction away from the front of the lamp 100.

Lens 144 may be arranged to disperse, focus, collimate, color, or otherwise modify a characteristic of light 120 passing therethrough. Alternatively, or in addition, lens 144 may be configured as a protective shield for a module 108, or lamp 100. In certain cases, a collimating lens may be disposed in the space 146 located between LED 118 and a distal end 148 of module 108. Desirably, such collimating lens is placed in proximity to the discharge opening of the parabolic reflector 122 to reduce a length of the light module 108. In a currently preferred embodiment of lamp 100, modules 108 are about 2 ½ inches in length. and approximate the size in a thickness direction of the lamp 100.

The lamp can further include a plurality of Lens in the tubes, with at least one lens per tube located at the open end thereof for directing the light from the LEDs toward the front of the lamp in a pattern that focuses light from the lamp to a central area of illumination of high intensity, with significantly reduced intensity illumination outside the central area. The lamp may also include a lens member at the front of the lamp presenting a plurality of individual lens sections over the face thereof arranged in a pattern corresponding to the position of the plurality of tubes, each lens section being aligned with a respective tube for directing light from the LED in that tube toward the front of the lamp in a pattern that focuses light from the lamp to a central area of illumination of high intensity, with significantly reduced intensity illumination outside the central area.

In another embodiment, a dental operatory lamp used to illuminate an operating area comprises a housing having a front directed toward the operating area and a rear away from the operating area, and a reflector module located at the rear of the housing. A plurality of LEDs is located on the reflector module. An electrical power supply is provided for supplying electrical power to the LEDs for illuminating the LEDs, with the power supply being selectively operable to provide an intensity adjustment for the LEDs. The electrical power supply can be selectively operable to control the level of power transmitted to each LED independent of the level of power transmitted to the other LEDs. The lamp can be configured to have a variable color output. The intensity adjustment can range from 0 to about 2500 FC. The intensity adjustment can be continuous throughout its range of adjustments or, alternatively, can be adjustable at discrete settings within its range of adjustments. The lamp may further include a microprocessor in communication with the LEDs to control the level of power transmitted to the LED's, and thus the output intensity of the light from the lamp. Suitable microprocessors for use with the present invention are well known in the art and include, but are not limited to, any programmable digital electronic component that incorporates the functions of a central processing unit (CPU) on a single semiconducting integrated circuit (IC).

In an alternative embodiment of the invention, a dental operatory lamp used to illuminate an operating area comprises a housing having a front directed toward the operating area and a rear facing away from the operating area. A plurality of light emitting diodes (LEDs) is included, with each LED being positioned in a respective stay light tube. An adapter configured for receiving at least one non-light emitting diode (non-LED) light source is located within the housing. The at least one non-LED light source may consist of a group of lights that can be selected from, for example, Quartz halogen, tungsten halogen, incandescent xenon, fluorescent, fiber optics, gas plasma, laser, ultraviolet, and blue light. The at least one non-LED light source may also include the group of lights selected from, for example, dental curing light, oral cancer screening light, decay detection (cavities and caries) blood detection sterilization and tooth whitening light.

A particular embodiment of the invention includes a dental operatory lamp used to illuminate an operating area having a housing with a front directed toward the operating area and a rear away from the operating area. At least one reflector module 108 at the rear of the housing comprises a plurality of tubes 134, wherein the tubes 134 are positioned with their longitudinal axes aligned toward predetermined points within the operating area for directing the light from the LEDs 118 toward the front of the lamp in a pattern that focuses light from the lamp to a central area of illumination of high intensity 204, with significantly reduced intensity illumination 202 outside the central area. The reflector module(s) 108 may include a plurality of light emitting diodes (LEDs), one of the LEDs being positioned in each of the tubes, and a portion of the respective tube projecting forward of the LED toward the front of the lamp to direct the light emitted from the LED toward the operating area.

Particular representative patterns of focused light emanating from the dental operatory lamps of the present invention are illustrated in FIG. 4. For example, the pattern of focused light can be an elliptical shaped pattern and may be about 3 inches by about 6 inches in size. In a particular embodiment, the reduced intensity illumination 202 outside the central area of illumination 204 decreases in intensity by 50% of a maximum intensity relative to the central area of illumination of high intensity. The central area of illumination of high intensity 204 can have a pattern size of at least 50 mm by 25 mm. The reduced intensity illumination 202 outside the central area can be configured to decrease in intensity progressively and smoothly relative to the central area of illumination of high intensity. The pattern can be configured to have a brightness of greater than about 20,000 Lux at a focus height of 700 mm from a target. The illumination on the central area of illumination of high intensity 204 at a distance of 60 mm can be configured to be less than about 1200 Lux. Illumination at the maximum level of the dental operating light in the spectral region of 180 nm to 400 nm can be configured to not exceed 0.008 W/m2.

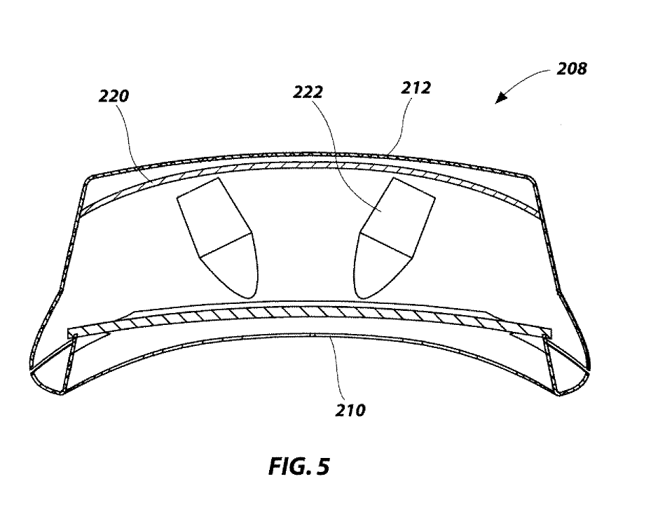

Yet another embodiment of the invention is shown in FIG. 5, wherein a dental operatory lamp used to illuminate an operating area includes a lamp assembly 208 having a front 210 directed toward the operating area and a rear 212 away from the operating area. A reflector module 220 can be located within the lamp assembly 208, and more specifically. can be located at the rear 212 of the lamp assembly 208. A plurality of light emitting diodes (LEDs) can be located in the reflector module 222. The lamp assembly 208 can include a curved or faceted interior reflective surface 220. The LEDs can be directed toward the curved or faceted interior reflective surface 220 for directing the light from the LEDs toward the front 210 of the lamp in a pattern that focuses light from the lamp to a central area of illumination of high intensity, with significantly reduced intensity illumination outside the central area. The reduced intensity illumination outside the central area can be configured to decrease in intensity by 50% of a maximum intensity relative to the central area of illumination of high intensity. The reduced intensity illumination outside the central area may be configured to decrease in intensity progressively and smoothly relative to the central area of illumination of high intensity. The light pattern can have a brightness of greater than about 20,000 Lux at a focus height of 0.700 mm from a target. The illumination on the central area of illumination of high intensity at a distance of 60 mm may be less than about 1200 Lux. The illumination at the maximum level of the dental operating light in the spectral region of 180 nm to 400 nm may be configured to not exceed 0.008 W/m².

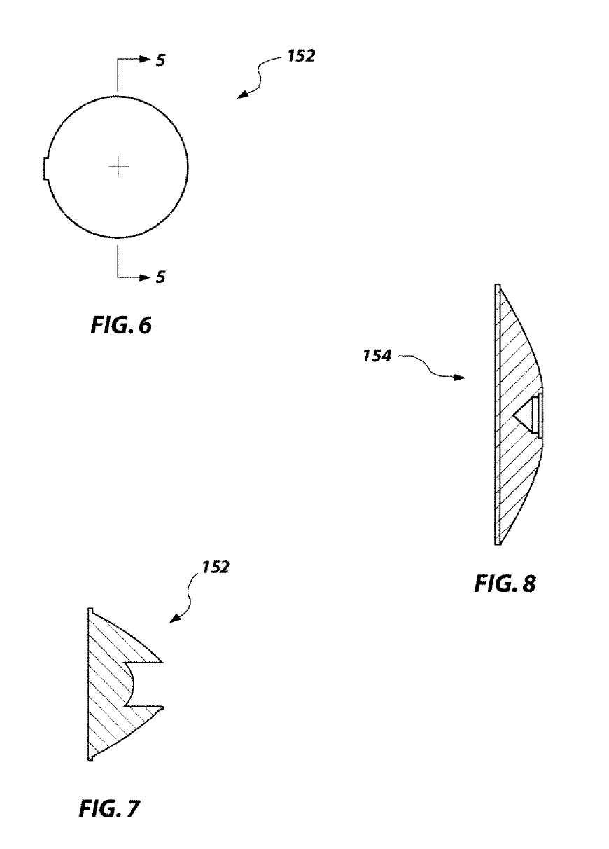

FIGS. 6-8 illustrate configurations of collimating lenses of use in certain embodiments constructed according to principles of the invention. Such lenses typically are structured to direct the LED's light output toward a target, and permit formation of lamp 100 in a compact form factor. A pair of operable collimating lenses, configured as TIR lenses, is illustrated in FIGS. 6-8. The first collimating TIR lens 152 (<4.5 deg. FWHM) is illustrated in end and section views in FIGS. 6 and 7, respectively. The second TIR lens (<2 deg. FWHM), illustrated in cross-section in FIG. 6 and is generally indicated at 154. Such lenses permit a reduction in length of the stray light tube or equivalent portion of a housing 132.

Lenses are designed in accordance with known optical parameters, including the relations set forth in Table 1. It is currently preferred to injection mold lenses from Lexane®, or other optically effective plastic material.

TABLE 1

Optical Power (single element)
Phi = (n′ − n)C = (n′ − n)/R
C = 1/R
f = fE = 1/phi
fF = −n/phi = ˜eta * fE
fE = −fF/n = f′R/n′
fR′ = n′/phi = n′fE
fR′/fF = −n′/n
Field or spot size limited by the f/# of the optical element:
z = −(1 − m)/m * fF
z′ = (1 − m)/fR′
Magnification factor:
m = −(z′/z) * (fF/fR′)
fR′/z′ + fF/z = 1

Although the foregoing description contains many specifics, these are not to be construed as limiting the scope of the present invention, but merely as providing certain representative embodiments. Similarly, other embodiments of the invention can be devised which do not depart from the spirit or scope of the present invention. The scope of the invention is, therefore, indicated and limited only by the appended claims and their legal equivalents, rather than by the foregoing description. All additions, deletions, and modifications to the invention, as disclosed herein, which fall within the meaning and scope of the claims, are encompassed by the present invention.

What is claimed is:

1. A dental operatory lamp used to illuminate an operating area comprising: a housing having a front directed toward the operating area and a rear away from the
operating area; at least one reflector module at the rear of the housing comprising a plurality of tubes,
wherein the tubes are positioned with their longitudinal axes aligned toward
predetermined points within the operating area for directing the light from the LEDs
toward the front of the lamp in a pattern that focuses light from the lamp to a central
area of illumination of high intensity, with significantly reduced intensity
illumination outside the central area; and a plurality of light emitting diodes (LEDs), one of the LEDs being positioned in each of
the tubes, and a portion of the respective tube projecting forward of the LED toward
the front of the lamp to direct the light emitted from the LED toward the operating
area.

2. The lamp of claim 1, wherein the pattern of focused light comprises an elliptical shaped pattern.

3. The lamp of claim 2, wherein the pattern of focused light is about 3 inches by about 6 inches.

4. The lamp of claim 1, wherein the reduced intensity illumination outside the central area decreases in intensity by 50% of a maximum intensity relative to the central area of illumination of high intensity.

5. The lamp of claim 1, wherein the central area of illumination of high intensity has a pattern size of at least 50 mm by 25 mm.

6. The lamp of claim 1, wherein the reduced intensity illumination outside the central area decreases in intensity progressively and smoothly relative to the central area of illumination of high intensity.

7. The lamp of claim 1, further comprising a plurality of lens in the tubes, with at least one lens per tube located at the open end thereof for directing the light from the LEDs toward the front of the lamp in a pattern that focuses light from the lamp to a central area of illumination of high intensity, with significantly reduced intensity illumination outside the central area.

8. The lamp of claim 1, further comprising a lens member at the front of the lamp presenting a plurality of individual lens sections over the face thereof arranged in a pattern corresponding to the position of the plurality of tubes, each lens section being aligned with a respective tube for directing light from the LED in that tube toward the front of the lamp in a pattern that focuses light from the lamp to a central area of illumination of high intensity, with significantly reduced intensity illumination outside the central area.

9. The lamp of claim 1, wherein the pattern has a brightness of greater than about 20,000 Lux at a focus height of 700 mm from a target.

10. The lamp assembly of claim 1, wherein an illumination on the central area of illumination of high intensity at a distance of 60 mm is less than about 1200 Lux.

11. The lamp assembly of claim 1, wherein an illumination at the maximum level of the dental operating light in the spectral region of 180 nm to 400 nm does not exceed 0.008 W/m².

12. A dental operatory lamp used to illuminate an operating area comprising:
a housing having a front directed toward the operating area and a rear away from the operating area;
a reflector module located at the rear of the housing;
a plurality of light emitting diodes (LEDs) on the reflector module;
an electrical power supply for supplying electrical power to the LEDs for illuminating the LEDs, with the power supply being selectively operable to provide an intensity adjustment for the LEDs.

13. The lamp of claim 12 wherein the electrical power supply is selectively operable to control the level of power transmitted to each LED independent of the level of power transmitted to the other LED's.

14. The lamp of claim 12, wherein the lamp has a variable color output.

15. The lamp of claim 12, wherein the intensity adjustment ranges from 0 to about 2500 FC.

16. The lamp of claim 12, wherein the intensity adjustment is continuous throughout its range of adjustments.

17. The lamp of claim 12, wherein the intensity adjustment is adjustable at discrete settings within its range of adjustments.

18. The lamp of claim 12, further comprising a microprocessor in communication with the LEDs to control the level of power transmitted to the LED's, and thus the output intensity of the light from the lamp.

19. A dental operatory lamp used to illuminate an operating area comprising: a housing having a front directed toward the operating area and a rear facing away from the operating area; a plurality of light emitting diodes (LEDs), each LED being positioned in a respective
stray light tube, and an adapter configured for receiving at least one non-light emitting diode (non-LED) light
source within the housing.

20. The lamp assembly of claim 19, wherein the at least one non-LED light source consists of the group of lights selected from Quartz halogen, tungsten halogen, incandescent, xenon, fluorescent, fiber optics, gas plasma, laser, ultraviolet, and blue light

21. The lamp assembly of claim 19, wherein the at least one non-LED light source consists of the group of lights selected from dental curing light, oral cancer screening light, decay detection (cavities and caries) blood detection sterilization, and tooth whitening light.

22. A dental operatory lamp used to illuminate an operating area comprising:
. a housing having a front directed toward the operating area and a rear away from the operating area;
a reflector module located at the rear of the housing;
a plurality of light emitting diodes (LEDs) on the reflector module; and
a curved or faceted interior reflective surface of the lamp housing, wherein the LEDs are directed toward the curved or faceted interior reflective surface at the rear of the housing for directing the light from the LEDs toward the front of the lamp in a pattern that focuses light from the lamp to a central area of illumination of high intensity, with significantly reduced intensity illumination outside the central area.

23. The lamp of claim 22, wherein the reduced intensity illumination outside the central area decreases in intensity by 50% of a maximum intensity relative to the central area of illumination of high intensity.

24. The lamp of claim 22, wherein the reduced intensity illumination outside the central area decreases in intensity progressively and smoothly relative to the central area of illumination of high intensity.

25. The lamp assembly of claim 22, wherein an illumination on the central area of illumination of high intensity at a distance of 60mm is less than about 1200 Lux.
